(19) United States
(12) Patent Application Publication
(10) Pub. No.: US 2011/0241602 A1
(43) Pub. Date: Oct. 6, 2011

(54) POWER SUPPLY DEVICE

(75) Inventors: CHIA-SHIN CHOU, Tu-Cheng (TW); ZHEN-XING YE, Shenzhen (CN)

(73) Assignees: HONG FU JIN PRECISION INDUSTRY (ShenZhen)CO., LTD., Shenzhen City (TW); HON HAI PRECISION INDUSTRY CO., LTD., Tu-Cheng (TW)

(21) Appl. No.: 12/831,350

(22) Filed: Jul. 7, 2010

(30) Foreign Application Priority Data
Apr. 1, 2010 (CN) 201010137723.8

(51) Int. Cl. H02J 7/00

(52) U.S. Cl. 320/101

(57) ABSTRACT

A power supply device for supplying electric power to a portable electronic device includes a rechargeable battery supplying electric power to the portable electronic device, a circuitry assembly connected to the battery, and a solar cell connected to the circuitry assembly. The solar cell transforms light irradiating thereon into electric power. The circuitry assembly detects the voltage of the battery, and charges the battery with the electric power generated by the solar cell when the voltage of the battery is lower than a predetermined value.

### BACKGROUND

1. Technical Field

The present disclosure relates to power supply devices used in portable electronic devices, and particularly to a solar power supply device used in portable electronic devices.

2. Description of Related Art

Rechargeable batteries are widely used in portable electronic devices, such as mobile phones, personal digital assistants (PDA), and laptop computers. When the rechargeable batteries are exhausted, the batteries may be connected to charging devices for recharging.

However, most conventional charging devices can only be used to connect the batteries with other power supplies (e.g., wall sockets) and input electric power of the power supplies to the batteries. These charging devices cannot be used to charge the batteries without being connected to other power supplies.

Therefore, there is room for improvement within the art.

### BRIEF DESCRIPTION OF THE DRAWINGS

Many aspects of the present power supply device can be better understood with reference to the following drawings. The components in the various drawings are not necessarily drawn to scale, the emphasis instead being placed upon clearly illustrating the principles of the present power supply device. Moreover, in the drawings, like reference numerals designate corresponding parts throughout the figures.

FIG. 1 is an assembled view of a power supply device, according to an exemplary embodiment.

FIG. 2 is a disassembled view of the power supply device shown in FIG. 1.

FIG. 3 is a block diagram of the power supply device shown in FIG. 1.

### DETAILED DESCRIPTION

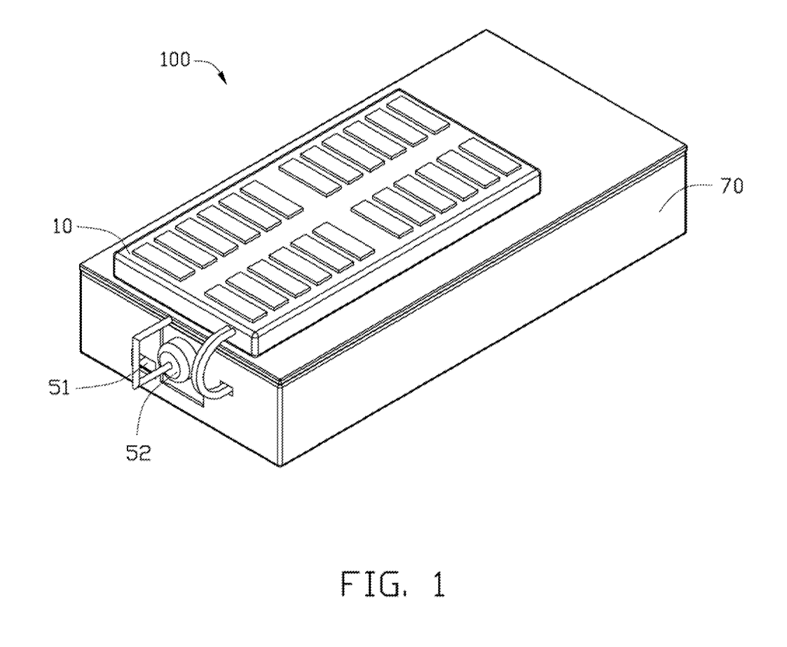

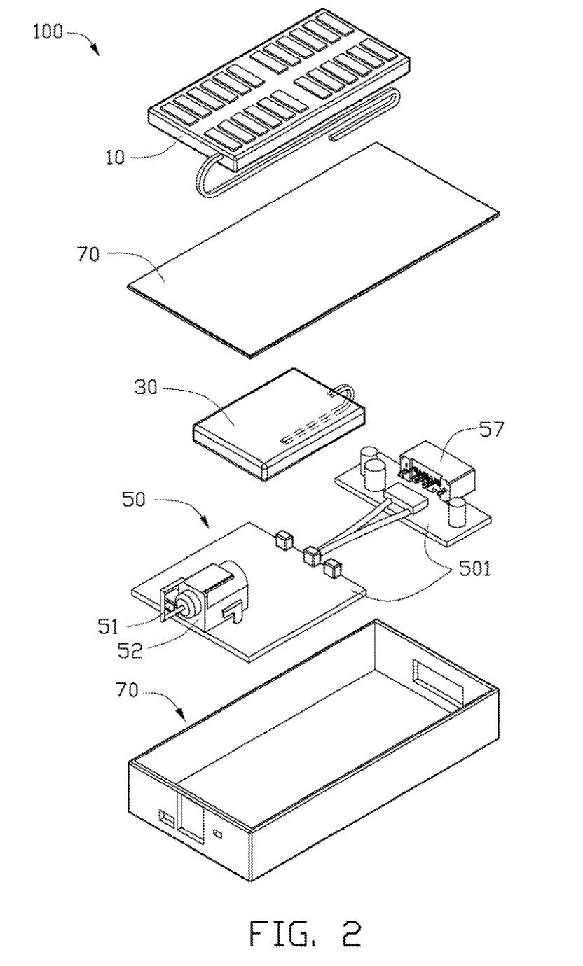

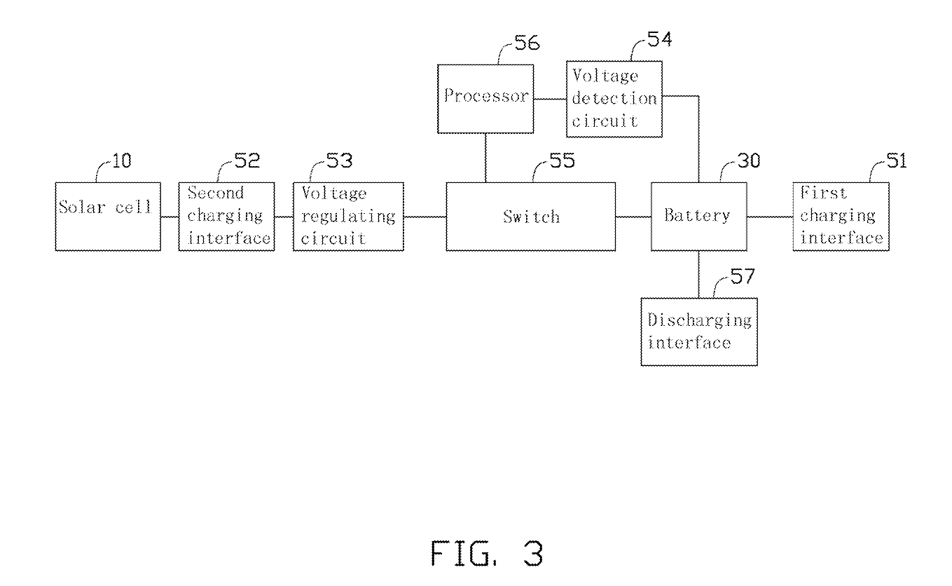

FIGS. 1-3 show a power supply device 100, according to an exemplary embodiment. The power supply device 100 can be used to supply electric power to portable electronic devices (not shown), such as mobile phones, personal digital assistants (PDA), or laptop computers. The power supply device 100 includes a solar cell 10, a rechargeable battery 30, a circuitry assembly 50, and a housing 70.

The housing 70 is substantially a case. The solar cell 70 is a thin film solar cell mounted on an outer surface of the housing 70. When sunlight irradiates the solar cell 10, the solar cell 10 transforms the sunlight into electric power. The battery 30 and the circuitry assembly 50 are both received in the housing 70. The solar cell 70 is electrically connected to the battery 30 via the circuitry assembly 50.

The circuitry assembly 50 includes a circuit board 501, a first charging interface 51, a second charging interface 52, a voltage regulating circuit 53, a voltage detection circuit 54, a switch 55, a processor 56, and a discharging interface 57. The voltage regulating circuit 53, the voltage detection circuit 54, the switch 55, and the processor 56 are integrated with the circuit board 501. The first charging interface 51, the second charging interface 52, and the discharging interface 57 are mounted on the circuit board 501.

The first charging interface 51 is a conventional charging interface electrically connected to the battery 30. The battery 30 can be connected to other power supplies (e.g., wall sockets) that are independent from the power supply device 100 via the first charging interface 51, such that the battery 30 can be recharged by the power supplies. The second charging interface 52 is electrically connected to the solar cell 10. Electric power generated by the solar cell 10 can be input to the circuitry assembly 50 via the second charging interface 52. The voltage regulating circuit 53 is electrically connected to the second charging interface 52, and is also electrically connected to the battery 30 via the switch 55. The voltage regulating circuit 53 can regulate the voltage input from the second charging interface 52 to predetermined values, and can transmit electric power having regulated voltage to the battery 30 when the switch 55 is switched on.

The processor 56 is electrically connected to the switch 55 to control the switch 55 to be switched on/off, and is also electrically connected to the voltage detection circuit 54. The voltage detection circuit 54 is electrically connected to the battery 30. The voltage detection 54 can detect the voltage of the battery 30 and transmit the voltage value of the battery 30 to the processor 56. The discharging interface 57 is a universal serial bus (USB) interface electrically connected to the battery 30. Portable electronic devices (not shown), such as mobile phones, PDAs, and laptop computers, can be connected to the power supply device 100 via the discharging interface 57, and thus the battery 30 can supply electric power to the portable electronic devices via the discharging interface 57.

In use, the discharging interface 57 of the power supply device 100 is electrically connected to a portable electronic device (not shown), and the battery 30 supplies electric power to the portable electronic devices via the discharging interface 57. The voltage detection circuit 54 detects the voltage on the battery 30 and transmits the detected voltage value to the processor 56.

When the voltage value of the battery 30 is lower than a predetermined value, the processor 56 determines that much electric power of the battery 30 is consumed and the battery 30 needs to be recharged. Thus, the processor 56 controls the switch 55 to be switched on. If the power supply device 100 is positioned under sunlight, the solar cell 10 transforms the sunlight irradiating thereon into electric power. Electric power generated by the solar cell 10 is then input to the voltage regulating circuit 53 via the second charging interface 52. The voltage regulating circuit 53 regulates the voltage of the electric power to a predetermined value for charging, and transmits the electric power having the regulated voltage to the battery 30 via the switch 55 to recharge the battery 30.

When the battery 30 is fully charged, the voltage value of the battery 30 increases to exceed the predetermined value. The voltage detection circuit 54 detects the increased voltage value of the battery 30 and transmits the increased value to the processor 56. The processor 56 determines that the battery 30 is fully charged according to the voltage value that exceeds the predetermined value, and then controls the switch 55 to be switched off. Thus, electric power generated by the solar cell 10 is prevented from being input to the battery 30, so the battery 30 is protected from overcharging.

As detailed above, the battery 30 is recharged by power provided to the power supply device 100 by solar energy. Despite the absence of another power supply, the battery 30 can be recharged and continuously supply electric power to the portable electronic device.

The power supply device 100 can also be connected to another power supply that is independent from the power supply device 100 via the first charging interface 51 to recharge the battery 30 by conventional methods. Furthermore, the battery 30 is detachable and replaceable. After the battery 30 is recharged, it can also be detached from the power supply device 100 and installed in portable electronic devices to supply electric power. When the battery 30 is separated from the power supply device 100, other conventional rechargeable batteries (not shown) can also be connected to the switch 55 and be recharged similarly to the battery 30.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A power supply device for supplying electric power to a portable electronic device, comprising:
a rechargeable battery supplying electric power to the portable electronic device;
a circuitry assembly connected to the battery; and
a solar cell connected to the circuitry assembly; wherein the solar cell transforms light irradiating thereon into electric power; the circuitry assembly detects the voltage of the battery, and charges the battery with the electric power generated by the solar cell when the voltage of the battery is lower than a predetermined value.

2. The power supply device as claimed in claim 1, wherein the circuitry assembly includes a processor, a voltage detection circuit, and a switch; the processor connected to the battery via the voltage detection circuit, the solar cell connected to the battery via the switch, and the processor connected to the switch; the processor detecting the voltage of the battery using the voltage detection circuit and controlling the switch to be switched on when the voltage of the battery is lower than the predetermined value, thereby transmitting the electric power generated by the solar cell to the battery via the switch to charge the battery.

3. The power supply device as claimed in claim 2, wherein the circuitry assembly further includes a voltage regulating circuit, the solar cell connected to the switch via the voltage regulating circuit.

4. The power supply device as claimed in claim 1, further comprising a charging interface connecting the battery to another power supply that is independent from the power supply device to charge the battery.

5. The power supply device as claimed in claim 1, further comprising a discharging interface connecting the battery to the portable electronic device to supply electric power to the portable electronic device, wherein the discharging interface is a universal serial bus (USB) interface.

6. The power supply device as claimed in claim 1, wherein the battery is detachable and replaceable.
